(19) United States
(12) Patent Application Publication
(10) Pub. No.: US 2014/0230587 A1
(43) Pub. Date: Aug. 21, 2014

(54) Thumb Assembly

(71) Applicant: CATERPILLAR INC., Peoria, IL (US)

(72) Inventors: Ryan P. Shea, Manhattan, KS (US); Aaron D. Kovar, Topeka, KS (US)

(73) Assignee: CATERPILLAR INC., Peoria, IL (US)

(21) Appl. No.: 13/772,137

(22) Filed: Feb. 20, 2013

(51) Int. Cl. F16H 21/44

(52) U.S. Cl. CPC F16H 21/44
USPC 74/103

(57) ABSTRACT

A thumb actuator for a no-link type thumb assembly includes a cylinder body configured to be pivotally connected to a mounting bracket. The thumb actuator further includes a piston assembly having a piston and a piston rod configured to be pivotally connected to a thumb. Further, a ratio of a retracted length to a stroke length of the thumb actuator is in a range of about 1.9 to 2.2.

### TECHNICAL FIELD

The present disclosure relates to a thumb assembly and more particularly to a no-link type thumb assembly.

### BACKGROUND

Earthmoving machines, for example, excavating equipment is commonly used to move large amounts of earth, rocks or other cylindrical members. Excavators including backhoes and other types of excavating equipment commonly include a boom member, which extends from a main body of the machine. Further, a stick member pivotally connected to the boom member and an implement pivotally attached to an end of the stick member. While these types of excavators are well suited for moving loose dirt and small rocks, they are not as well suited for picking up larger objects that do not fit easily into the implement. Excavators include an additional attachment such as a fixed or movable thumb that opposes the movement of the implement and facilitates grabbing and moving rocks, pipes, concrete, trees, and other larger objects.

Moreover, the thumb is connected to a cylinder, wherein the cylinder is further connected to a bracket provided on the stick member. The stick member typically requires different bracket locations for a link-type thumb and a no-link type thumb. Dealers or operators may need to weld brackets on the stick member at the work location separately for the link-type thumb and the no-link type thumb. The on-location welding of the brackets to the stick member may reduce the life of the stick life which has been post-weld stress-relieved at the machine factory. To overcome the problem set forth above, one solution is to modify the design of the no-link cylinder to allow for a consistent bracket location on the stick member for the link-type thumb and the no-link type thumb. In one example, U.S. Pat. No. 5,167,182 discloses a fluid actuator assembly comprising a plurality of modules which are secured in serial relation to form a body of the fluid actuator. However, there is still scope for improvement of the art.

### SUMMARY

In one aspect, the present disclosure provides a thumb actuator for a no-link type thumb assembly including a cylinder body configured to be pivotally connected to a mounting bracket. The thumb actuator further includes a piston assembly having a piston and a piston rod configured to be pivotally connected to a thumb. Further, a ratio of a retracted length to a stroke length of the thumb actuator is in a range of about 1.9 to 2.2.

In an another aspect, the present disclosure provides the thumb actuator for a link-type thumb assembly and a no-link type thumb assembly configured to be attached with the mounting bracket. Further, the mounting bracket is provided at a substantially equal pre-determined distance from a stick pin for the link-type thumb assembly and the no-link type thumb assembly.

Other features and aspects of this disclosure will be apparent from the following description and the accompanying drawings.

### BRIEF DESCRIPTION OF THE DRAWINGS

FIG. 1 illustrates a side view of a machine with a no-link type thumb assembly;

FIG. 2 illustrates a side view of a stick member with a thumb actuator in a retracted position;

FIG. 3 illustrates a side view of a stick member with the thumb actuator in an extended position;

FIG. 4 illustrates aside view of a thumb actuator in retracted position, according to an aspect of the present disclosure; and

FIG. 5 illustrates a side view of a machine with a link-type thumb assembly.

### DETAILED DESCRIPTION

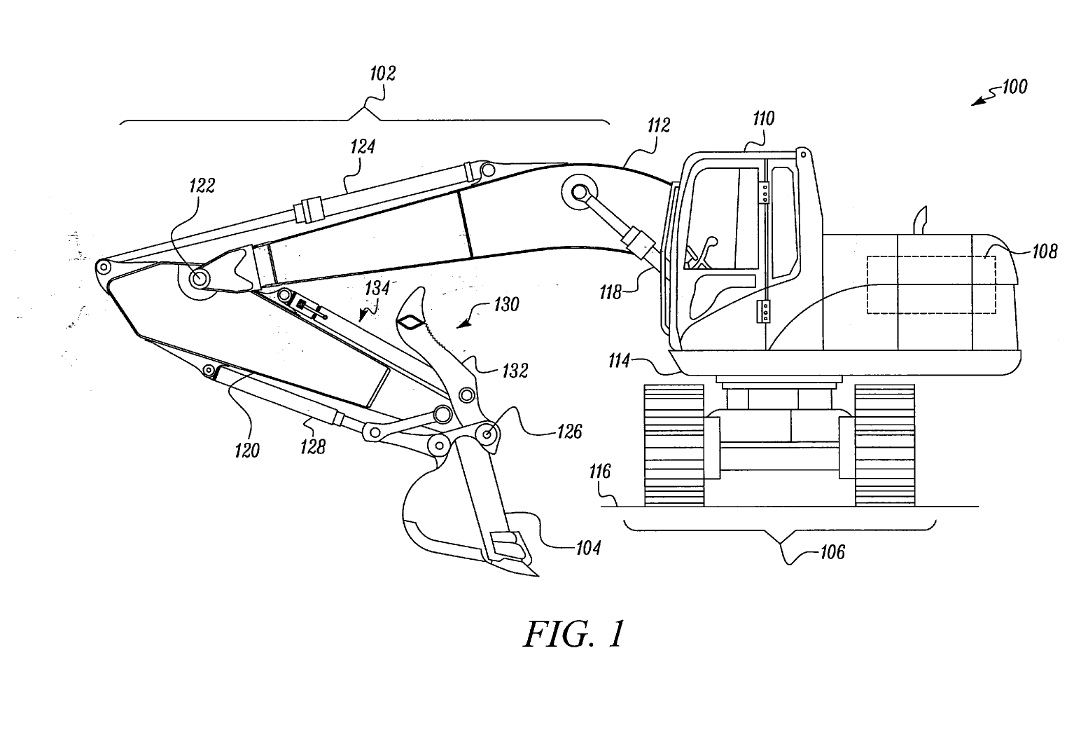

FIG. 1 illustrates a side view of a machine 100, such as a hydraulic implemented. The machine 100 may include an implement system 102 configured to move an implement 104, a drive system 106 for propelling the machine 100, a power source 108 that provides power to the implement system 102 and the drive system 106, and an operator station 110 to control the movement of the implement 104 and the machine 100.

As illustrated in FIG. 1, the implement system 102 may include a boom member 112 pivotally connected to a frame 114 of the machine 100 and configured to pivot in a vertical plane about a first horizontal axis (not shown) relative to a ground 116 by a pair of first hydraulic actuators 118 (only one side shown in FIG. 1). The implement system 102 may also include a stick member 120 pivotally connected to the boom member 112 and configured to pivot in the vertical plane about a second horizontal axis 122 by a second hydraulic actuator 124. Further, the implement 104 is pivotally connected to the stick member 120 and configured to pivot in the vertical plane about a third horizontal axis 126 by a third hydraulic actuator 128.

According to an embodiment, the implement system 102 further includes a no-link type thumb assembly 130. The no-link type thumb assembly 130 may include a thumb 132 pivotally connected to the stick member 120 and also configured to pivot in the vertical plane about the third horizontal axis 126 by a thumb actuator 134. The power source 108 may embody an engine such as, for example, a diesel engine, a gasoline engine, a gaseous fuel-powered engine, or any other type of combustion engine known in the art. It is contemplated that the power source 108 may alternatively embody a non-combustion source of power such as a fuel cell, a power storage device, or another source known in the art. The power source 108 may produce a mechanical or electrical power output that may be used to pressurize a hydraulic fluid for moving the hydraulic actuators 118, 124, 128 and 134.

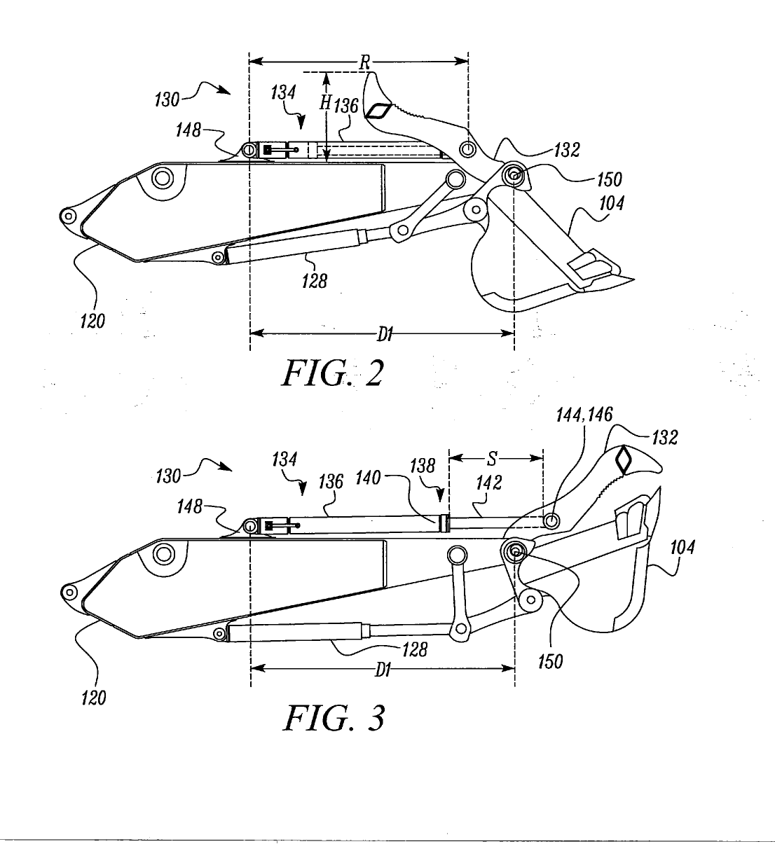

FIGS. 2 and 3 illustrate, a perspective view of the stick member 120 and the no-link type thumb assembly 130 with the thumb actuator 134 in a retracted position and an extended position, respectively. As illustrated, the thumb actuator 134 may have a retracted length R corresponding to the retracted position (see FIG. 2) and a stroke length S corresponding to the extended position (see FIG. 3). Further, as illustrated in FIG. 2, in the retracted position, the thumb 132 is in a stowed position at a stow height H with respect to the stick member 120. In an aspect of the present disclosure, a ratio of the retracted length R to the stroke length S, of the thumb actuator 134, may lie in a pre-determined range from about 1.9 to 2.2. In an embodiment, the ratio of the retracted length R to the stroke length S may be 2.1. It will be apparent to a person having ordinary skill in the art that the pre-determined range for the ratio of the retracted length R to the stroke length S is exemplary and may vary based on the application and the size of the machine 100.

According to an embodiment, the thumb actuator 134 includes a cylinder body 136 and a piston assembly 138. The piston assembly 138 may include a piston 140 and a piston rod 142 (see FIG. 3), such that a distal end 144 of the piston rod 142 is pivotally connected to the thumb 132 at an attachment point 146. Further, the cylinder body 136 is pivotally connected to a mounting bracket 148 disposed on the stick member 120. In an embodiment of the present disclosure, the mounting bracket 148 may be attached to the stick member 120 at a pre-determined distance D1 from a stick pin 150 by various well known fastening means for example, but not limited to, welding, bolts. Moreover, the mounting bracket 148 may be formed integral with the stick member 120. Further, it will be apparent to a person having ordinary skill in the art that the stick pin 150 may be a distal point on the stick member 120 and may or may not coincide with the third horizontal axis 126.

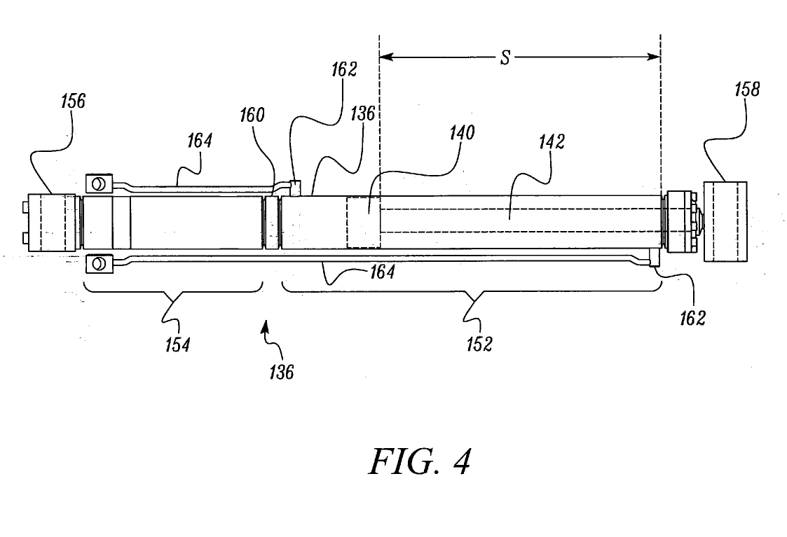

FIG. 4 illustrates a side view of the thumb actuator 134, according to an aspect of the present disclosure. The cylinder body 136 of the thumb actuator 134 may include a main portion 152 and an extension portion 154 such that the piston 140 (as shown in dashed lines) is configured to reciprocate substantially within the main portion 152. In an aspect, the extension portion 154 may be an unoccupied or empty structure such that the extension portion 154 may increase the retracted length R of the thumb actuator 134 corresponding to the retracted position of the thumb actuator 134. Further, a first barrel pin bore 156 configured to interconnect the mounting bracket 148 (see FIGS. 1-3) and the extension portion 154. A second barrel pin bore 158 is configured to be connected to the attachment point 146 on the thumb 132 (see FIGS. 1-3). An end plate 160, for example a solid plate, may be configured to interconnect the extension portion 154 and the main portion 152 of the cylinder body 136. Further, the cylinder body 136 may include ports 162 at each end of the main portion 152 and configured to supply a hydraulic fluid for both the retraction and extension of the piston 140. The ports 162 may further be connected to hydraulic tubes 164 which traverse the main portion 152 and the extension portion 154, and terminate close to the first barrel pin bore 156 to minimize rotational movement of hydraulic hoses and fittings during normal operation.

### INDUSTRIAL APPLICABILITY

The industrial applicability of the no-link type thumb assembly 130 described herein will be readily appreciated from the foregoing discussion. Although, in the illustrated embodiment, the machine 100 is embodied as the hydraulic excavator, in various other embodiments, the machine 100 may be, but not limited to, an, a backhoe loader, an industrial loader, a skidder, an excavator, and a hydraulic shovel, or the like. The machine 100 may be a fixed or mobile machine that performs operations associated with an industry such as mining, construction, demolition, farming, or any other industry known in the art.

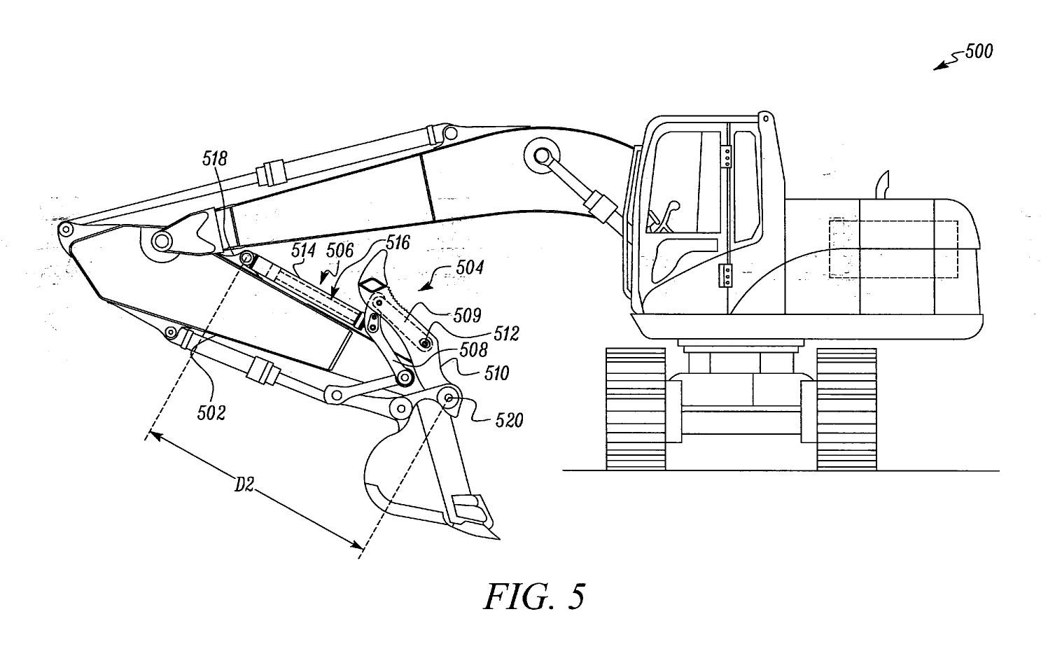

FIG. 5 illustrates a perspective view of a machine 500 with a stick member 502 with a link-type thumb assembly 504 which is pivotally connected to the stick member 502 by a thumb actuator 506. The link-type thumb assembly 504 may include a first link member 508 pivotally connected to the stick member 502. The first link member 508 is further connected to a second link member 509. Further, the second link member 509 is connected to an attachment point 512 provided on a thumb 510. The thumb actuator 506 includes a cylinder body 514 and a piston assembly 516. The piston assembly 516 is pivotally connected to the first link member 508. Further, the cylinder body 514 is pivotally connected to a mounting bracket 518 disposed on the stick member 502. In an embodiment of the present disclosure, the mounting bracket 518 may be attached to the stick member 502 at a pre-determined distance D2 from a stick pin 520 by various well known fastening means for example, but not limited to, welding, bolts.

As illustrated in FIGS. 3 and 5, in an aspect of the present disclosure, a singular mounting bracket 148, 518 location on the stick members 120, 502 is achieved for the no-link type thumb assembly 130 and the link-type thumb assembly 504 by inclusion of the extension portion 154 with the main portion 152 of the cylinder body 136 in case of the no-link type thumb assembly 130. According to an aspect, the pre-determined distance D1 of the mounting bracket 148 from the stick pin 150 of the no-link type thumb assembly 130 is substantially equal to the pre-determined distance D2 of mounting bracket 518 from the stick pin 520 of the link-type thumb assembly 504.

In an aspect of the present disclosure, the addition of extension portion 154 may imply a singular location of the mounting bracket 148, 518 in terms of the pre-determined distance D1, D2 for the no-link type thumb assembly 130 and the link-type thumb assembly 504. This may increase the life of the stick members 120, 502. Further, the stick members 120, 502 of the machines 100, 500 with the mounting bracket 148, 518 may be a single factory assembled thumb-ready stick for use with the no-link type thumb assembly 130 and the link-type thumb assembly 504. In an aspect of the present disclosure, the ratio of retracted length R to the stroke length S being in the pre-determined range from about 1.9 to 2.2 may decrease the stowed heights H of the no-link type thumb assembly 130, while maintain a high degree of rotation of the thumb 132. Moreover, the thumb actuator 134 having the ratio of retracted length R to the stroke length S of within the pre-determined range also maintains a resistance to buckling conditions.

It will be appreciated that the foregoing description provides examples of the disclosed system and technique. However, it is contemplated that other implementations of the disclosure may differ in detail from the foregoing examples. All references to the disclosure or examples thereof are intended to reference the particular example being discussed at that point and are not intended to imply any limitation as to the scope of the disclosure more generally. All language of distinction and disparagement with respect to pertain features is intended to indicate a lack of preference for those features, but not to exclude such from the scope of the disclosure entirely unless otherwise indicated.

Accordingly, this disclosure includes all modifications and equivalents of the subject matter recited in the claims appended hereto as permitted by applicable law. Moreover, any combination of the above-described elements in all possible variations thereof is encompassed by the disclosure unless otherwise indicated herein or otherwise clearly contradicted by context.

What is claimed is:

1. A thumb actuator for a no-link type thumb assembly comprising:
a cylinder body configured to be pivotally connected to a mounting bracket;
a piston assembly having a piston and a piston rod, the piston rod configured to be pivotally connected to a thumb; and
a ratio of a retracted length to a stroke length of the thumb actuator is in a range from about 1.9 to 2.2.

2. The thumb actuator of claim 1, wherein ratio of the retracted length to the stroke length is about 2.1.

3. The thumb actuator of claim 1, wherein the cylinder body includes a main portion and an extension portion.

4. The thumb actuator of claim 3, wherein the piston of the piston assembly is configured to reciprocate within the main portion of the cylinder body.

5. The thumb actuator of claim 3, wherein the extension portion configured to be pivotally connected to a mounting bracket.

6. The thumb actuator of claim 3 further comprising an end plate provided between the main portion and the extension portion.

7. An implement system for a machine comprising:
a stick member;
a mounting bracket disposed on the stick member; and
a thumb actuator each, for a link-type thumb assembly and a no-link type thumb assembly is configured to be attached with the mounting bracket.

8. The implement system of claim 7, wherein the mounting member is provided at a pre-determined distance from a stick pin substantially equal for the link-type thumb assembly and the no-link type thumb assembly.

9. The implement system. of claim 7, wherein the thumb actuator for the no-link type thumb assembly comprising:
a cylinder body configured to be pivotally connected to a mounting bracket;
a piston assembly having a piston and a piston rod, the piston rod configured to be pivotally connected to a thumb; and
a ratio of a retracted length to a stroke length of the thumb actuator is in a range of about 1.9 to 2.2.

10. The implement system of claim 9, wherein ratio of the retracted length to the stroke length is about 2.1.

11. The implement system of claim 9, wherein the cylinder body includes a main portion and an extension portion.

12. The implement system of claim 9, wherein the extension portion is configured to be pivotally connected to the mounting bracket.

13. The implement system of claim 9 further comprising an end plate provided between the main portion and the extension portion of the cylinder body

14. A machine comprising:
a stick member;
a mounting bracket disposed on the stick member; and
a thumb actuator each for a link-type thumb assembly and a no-link type thumb assembly is configured to be attached with the mounting bracket.

15. The machine of claim 13, wherein the mounting member is provided at a substantially equal pre-determined distance from a stick pin for the link-type thumb assembly and the no-link type thumb assembly.

16. The machine of claim 13, wherein the thumb actuator for the no-link type thumb assembly comprising:
a cylinder body configured to be pivotally connected to a mounting bracket;
a piston assembly having a piston and a piston rod, the piston rod configured to be pivotally connected to a thumb; and
a ratio of a retracted length to a stroke length of the thumb actuator is in a range of about 1.9 to 2.2.

17. The machine of claim 16, wherein ratio of the retracted length to the stroke length is about 2.1.

18. The machine of claim 15, wherein the cylinder body includes a main portion and an extension portion.

19. The machine of claim 15, wherein the extension portion is configured to be pivotally connected to the mounting bracket.

20. The machine of claim 15 further comprising an end plate provided between the main portion and the extension portion of the cylinder body.
